(19) United States
(12) Patent Application Publication
(10) Pub. No.: US 2023/0274349 A1
(43) Pub. Date: Aug. 31, 2023

(54) SYSTEMS AND METHODS FOR SHARED UTILITY ACCESSIBILITY

(71) Applicants: Solstice Initiative, Inc., Cambridge, MA (US); Massachusetts Institute of Technology, Cambridge, MA (US)

(72) Inventors: Stephanie Koo Speirs, Somerville, MA (US); Sandhya Murali, Weston, MA (US); Sruthi Sujani Davuluri, Chicago, IL (US); Chikara Onda, Loveland, CO (US); Christopher R. Knittel, Lexington, MA (US)

(21) Appl. No.: 17/769,561

(22) PCT Filed: Oct. 16, 2020
(86) PCT No.: PCT/US2020/056147

§ 371 Date: Apr. 15, 2022

Related U.S. Application Data
(60) Provisional application No. 62/923,261, filed on Oct. 18, 2019.

(51) Int. Cl. G06Q 40/12

(52) U.S. Cl. CPC G06Q 40/12

(57) ABSTRACT

The present invention provides predictive models for assessing an applicant's risk of defaulting on shared utility service bill payment, such as bill payment for community solar. Described are several alternatives to using FICO score to assess risk. Such alternatives include machine learning techniques (such as random forest classifier) as well as regression analysis.

This invention was made with government support under DE-EE0007659 awarded by the U.S. Department of Energy. The government has certain rights in the invention.

### FIELD OF THE INVENTION

The present invention relates to predictive models that provide an individual's probability of being delinquent on a utility bill payment, such as community solar payment. Using such models can increase accessibility, especially by lower-income households, to shared utility programs, including community solar services.

### BACKGROUND OF THE INVENTION

Most solar companies currently use credit scores to determine whom to approve for solar installations. Despite their widespread use, credit scores consider many aspects of a consumer's credit history that are not directly related to utility payment; therefore, the FICO score is an imperfect proxy for predicting utility payment performance. Furthermore, approximately 5 million low-income consumers, representing about 45% of consumers in low-income neighborhoods, are credit invisible or have unscored records. See CFPB, Who are the credit invisibles? how to help people with limited credit histories, Technical report, Washington D.C., 2016 (“CFPB report”). Traditional credit score cutoffs may therefore exclude people with low credit scores and those with insufficient credit history. At the same time, Low-to-Moderate Income (LMI) households bear a disproportionate energy burden, paying on average three times as much for energy as wealthier households. See Drehobl et al., Lifting the high energy burden in America's largest cities: How energy efficiency can improve low-income and under-served communities. Technical report, Washington D.C., 2016 (“Drehobl report”). Thus, by depending on credit scores as the sole indicator of consumer payment performance, the community solar market reproduces existing inequalities and limits its own potential for growth by excluding potential consumers. The present invention provides alternative and improved systems and methods for evaluating potential customers and their likelihood of defaulting on utility payments, so that individuals with no or poor credit scores and credit histories can nonetheless participate in community utility, including community solar, programs.

### SUMMARY OF THE INVENTION

The solar industry in the United States typically uses a credit score such as the FICO score as an indicator of consumer utility payment performance and credit worthiness to approve customers for new solar installations. The present invention provides alternative metrics and methods for predicting the probability of defaulting on utility bill payment, and for rendering enrollment eligibility decisions based on such predictions. Using payment performance data on over 800,000 utility service accounts and over 5,000 variables, machine learning and econometric models to predict the probability of default were compared to credit-score cutoffs. The models were compared across a variety of measures, including how they affect consumers of different socio-economic backgrounds and how they affect profitability. A traditional regression analysis using a small number of variables specific to utility repayment performance greatly increases accuracy and LMI inclusivity, relative to relying only on an applicant's FICO score to determine eligibility for enrollment in the utility service (e.g., determining eligibility based on a FICO score cutoff). Importantly, using machine learning techniques further enhances model performance. In certain embodiments of the invention, a random forest-based machine learning model, e.g., a random forest predictive model that uses over 5,000 variables, increases the number of low-to-moderate income consumers approved for community solar by 1.1% to 4.2%, depending on the stringency used for evaluating potential customers, while also decreasing the payment default rate by 1.4 to 1.9 percentage points. Using electricity utility repayment as a proxy for solar installation repayment, and shifting from a FICO score cutoff to a random forest-based machine learning model, can increase profits by 34% to 1882%, depending on the stringency used for evaluating potential customers.

Certain embodiments of the present invention relate to methods of providing (for example, to a utility service entity) an applicant's probability of delinquency for utility bill payment, the method comprising: (a) training a predictive model to provide probabilities of delinquency on utility bill payment, wherein the training is performed using a dataset comprising data points representing information associated with a number of individual utility service account holders; (b) collecting demographic data and financial data about an applicant; (c) applying the demographic data and financial data to the predictive model to obtain a probability of delinquency on utility bill payment for the applicant, and (d) providing the probability of delinquency on utility bill payment for the applicant to the utility service entity. The probability of delinquency that is obtained can be the probability of being at least 30 days past due on utility bill payment, the probability of being at least 60 days past due on utility bill payment, or the probability of being at least or over 90 days past due on utility bill payment.

In further embodiments, the applicant is given a determination of qualification for enrollment in a utility service, based on the applicant's probability of delinquency on utility bill payment as determined by the methods and systems described herein. Accordingly, in certain embodiments, the present invention provides methods for determining whether to qualify an applicant to enroll in a utility service, the method comprising: (a) training a predictive model to provide a probability of delinquency on utility bill payment, wherein the training is performed using a dataset comprising data points representing information associated with a number of individual utility service account holders; (b) collecting demographic data and financial data about an applicant, (c) applying the demographic data and financial data to the predictive model to obtain, for the applicant, a probability of delinquency on utility bill payment; (d) assigning to the applicant a determination of qualification for enrollment in the utility service that is based on the probability of delinquency on utility bill payment for the applicant; and (e) providing the determination of qualification for enrollment in the utility service to the utility service entity. The probability of delinquency that is obtained can be the probability of being at least 30 days past due, at least 60 days past due, or at least or over 90 days past due on utility bill payment.

In any of the aforementioned embodiments, the applicant may not have a FICO score. In addition or alternatively, the applicant may have a household income that is below the 60th percentile, below the 50th percentile, below the 40th percentile, below the 30th percentile, or below the 20th percentile of incomes in the applicant's county, city, or state of residence.

In certain embodiments, the probability of delinquency on utility bill payment is assessed for a number of applicants (e.g., 10, 25, 50, 75, 100, 200, 300, 500 or more applicants). For example, such embodiments of the methods and systems described herein may relate to methods of providing (for example, to a utility service entity) probabilities of utility payment delinquency for multiple applicants, the method comprising: (a) training a predictive model to provide probabilities of delinquency on utility bill payment, wherein the training is performed using a dataset comprising data points representing information associated with a number of individual utility service account holders; (b) collecting demographic data and financial data about each of said multiple applicants; (c) applying the demographic data and financial data to the predictive model to obtain, for each of said multiple applicants, a corresponding probability of delinquency on utility bill payment, and (d) providing said corresponding probability of delinquency for each of said multiple applicants to the utility service entity. In certain embodiments, each of the multiple applicants may be assigned a determination of qualification for enrollment in the utility service that is based on the applicant's probability of delinquency on utility bill payment, and these determinations of qualification for enrollment are provided to the utility service entity. In any of these embodiments, the probability of delinquency on utility bill payment that is obtained for each of the multiple applicants may be the probability of being at least 30 days past due, at least 60 days past due, or at least or over 90 days past due on utility bill payment. In additional embodiments, at least 5 percent, at least 10 percent, at least 15 percent, or at least 20 percent of the determinations are determinations that the applicant qualifies for enrollment. In certain embodiments, at least 1, 2, 3, 4, 5, or 10 percent or more of the determinations that the applicant qualifies for enrollment are determinations for applicants with no FICO score. In some embodiments, at least 1, 2, 3, 4, 5, or 10 percent or more of the determinations that the applicant qualifies for enrollment are determinations for applicants with household incomes that are below the 50th percentile, below the 40th percentile, or below the 30th percentile of household incomes in the applicant's county, city, or state of residence.

Embodiments of the present invention also provide methods of enrolling one or more applicants in a utility service. In one embodiment, the method comprises enrolling in the utility service at least one applicant based on the applicant's probability of delinquency on utility bill payment, wherein the applicant's probability of delinquency is determined by applying demographic data and financial data for the applicant to a predictive model that has been trained, tested, and validated using a dataset comprising data points representing past information associated with a number of individual utility service account holders. The probability of delinquency can be a probability of being at least 90 days past due on a utility bill payment, for example, or it can be a probability of being at least 30 days or at least 60 days past due on a utility bill payment. The applicants may not have a FICO score, and/or may have a household income that is below, e.g., the 40th percentile of incomes in the applicant's county of residence.

In any of the above embodiments and in other embodiments described herein, the predictive model may be a model that was trained, tested, and validated according to a machine learning technique. In certain embodiments, the machine learning technique comprises random forest classification. To generate the predictive model, in certain embodiments such as the embodiments described above, the number of individual utility service account holders is at least 800,000. In further embodiments the predictive model includes at least 5,000 features, each of the features being weighted according to the feature's contribution in the predictive model for predicting probability of delinquency on utility bill payment, wherein none of the twenty (20) highest-weighted features is a demographic variable. In some embodiments, none of the 50 highest-weighted features is a demographic variable, and in further embodiments, none of the 100 highest-weighted features is a demographic variable.

Further embodiments of the present invention provide a method of obtaining a probability of delinquency for an applicant's payment in a community shared utility, the method comprising: (a) training a random forest predictive model to provide probability of delinquency on utility bill payment, wherein the training is performed using a dataset comprising data points representing information associated with a number of individual utility service account holders; (b) collecting an applicant's demographic data and financial data; and (c) applying the demographic data and financial data to the random forest predictive model to obtain a probability of delinquency for the applicant's payment in a community shared utility. In certain embodiments, the probability of delinquency that is obtained is the probability of being at least or over 90 days past due on a utility bill payment.

Also described herein are methods, and a non-transitory computer-readable medium having stored thereon computer-readable instructions that when executed by a computing device cause the computing device to perform a method, the method comprising: (a) storing, in a database, demographic data and financial data for each member of a group of individual utility account holders; (b) evaluating, by a computing apparatus, a plurality of pre-defined features from each member of the group of individual utility account holders based on the demographic data and the financial data stored in the database; (c) generating, by the computing apparatus, an aggregated dataset of the pre-defined features; (d) separating, by the computing apparatus, the aggregated dataset into a training dataset and a test dataset; (c) applying, by the computing apparatus, a machine learning technique to the training dataset to derive a predictive model that correlates the features for each of said individual utility account holders with a probability of delinquency on a utility bill payment; (d) applying, by the computing apparatus, the predictive model to the testing dataset to yield a determination of whether the accuracy of predictions from the predictive model is above a pre-defined threshold; and (e) following a determination that the accuracy of predictions from the predictive model for the testing dataset is above the pre-defined threshold, applying, by the computing apparatus, the predictive model to an applicant's demographic data and financial data to generate a prediction as to whether the applicant will be delinquent on a utility bill payment. The machine learning technique may be a random forest analysis. In some embodiments, the plurality of pre-defined features comprises at least 5,000 features. In certain embodiments, the method performed by the computing device further comprises: computing, by the computing apparatus, contributions of the pre-defined features in the predictive model for making predictions; ranking, by the computing apparatus, the pre-defined features based on the contributions of the features; and providing, by the computing apparatus and based on the ranking, a user interface presenting top-contributing features in the predictive model for making predictions. In some embodiments, the 100 top-contributing features are financial and not demographic variables.

Embodiments of the present invention also provide a non-transitory computer-readable medium having stored thereon computer-readable instructions that when executed by a computing device cause the computing device to: (a) access an individual's demographic data and financial data from memory; (b) process the individual's demographic data and financial data through a predictive model to compute the individual's probability of being delinquent on utility bill payment. In certain embodiments, the predictive model is a random forest classifier. In further embodiments, the random forest classifier uses at least 5,000 features; the features can be weighted according to their respective contributions in predicting delinquency in utility bill payment, and in some embodiments, the 50 top-contributing features are financial and not demographic variables. In still further embodiments, the 100 top-contributing features are financial and not demographic variables. The probability of being delinquent can be a probability of being at least 90 days past due on utility bill payment, for example, or it can be a probability of being 30 days or 60 days past due on utility bill payment.

Additional embodiments and features of the systems and methods of the present invention are described below.

### BRIEF DESCRIPTION OF THE DRAWINGS

FIG. 1 provides a visual representation of a random forest predictive model according to an embodiment of the invention.

FIG. 2 is a diagram depicting the training, validation, and test datasets to develop a random forest classifier as described herein.

FIG. 3 is a graph comparing individuals' probabilities of non-delinquency determined by a random forest model as described herein, versus the individuals' FICO Scores.

FIG. 4 provides a set of graphs comparing the accuracy rates for three different models for predicting delinquency, using 30-day and 90-day definitions of delinquency; the three models include a random forest model, a traditional regression-based analysis, and FICO scores.

FIG. 5 provides a set of graphs comparing the default rates, using 30-day and 90-day delinquency definitions, among the random forest model, the traditional regression-based analysis, and FICO scores.

FIG. 6 is a graphical depiction of how the predictive models described herein can be used to determine whether an individual qualifies for enrollment in a community utility service.

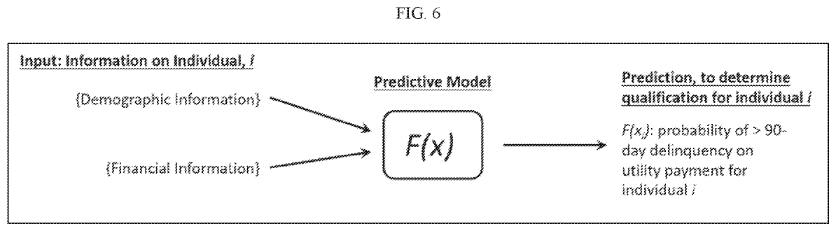

### DETAILED DESCRIPTION OF THE INVENTION

The present invention provides prediction models, including models based on machine learning analysis, for determining an individual's probability of delinquency on a utility bill. The models can be used to determine the individual's eligibility for enrollment in a shared utility service. Certain embodiments provide machine learning models, which provide improved predictions compared to other methods of determining enrollment eligibility, such as credit score-based cutoffs.

In certain embodiments, the present invention provides a machine learning model that predicts the probability of non-delinquency of utility bill payments, wherein the model is trained, tested, and validated using a large data set of utility repayment and other financial data obtained from a credit reporting agency (CRA). In specific embodiments, the machine learning model is based on a random forest model. In other embodiments, the machine learning model may be based on a least absolute shrinkage and selection operator (LASSO) technique, or on a support vector machine (SVM) technique. The machine learning model's overall forecasting performance, as well as its implications for LMI consumers, was compared to traditional credit metrics. Specifically, as described herein, the machine learning model's overall forecasting performance greatly increases accuracy and LMI inclusivity relative to using a FICO score-based cutoff to determine enrollment eligibility. In certain embodiments, the machine learning model increases the number of LMI applicants approved (deemed eligible for enrollment) by 1.1% to 4.2% depending on the stringency used in evaluating potential customers, while decreasing the default rate by 1.4 to 1.9 percentage points. As demonstrated herein, it is possible to extend shared utility services, such as community solar, to a larger number of qualified applicants with lower or no credit scores, while at the same time decreasing default risk, thus opening access to an untapped, low-risk market segment.

A broad review of the community shared solar (CSS), its current qualifying mechanism, and of the use of alternative credit qualifying scores across various industries is provided, followed by a description of the data set and data processing. The description below also outlines the models underlying the prediction models. In particular, traditional regression methods and machine learning techniques were used on account-level payment performance, financial data, and demographic data to predict the probability of delinquency. The models developed herein were then compared to a method using FICO score alone to predict probability of delinquency; the models and FICO score-based method are compared with respect to accuracy, default rates, and LMI inclusion. Profitability was also analyzed.

### Community Shared Solar

Community shared solar (CSS), a form of community shared utility service, provides a solution to expand solar access to consumers currently locked out of the rooftop solar market. In a community shared solar project, individuals subscribe to an off-site solar farm from which they receive credits on their electricity bill. This model is particularly attractive for those who have explored rooftop solar but are not eligible. Approximately 80% of Americans are currently locked out of the solar market. These individuals include renters, members of households with unsuitable roofs, and individuals who are unable to afford the high cost of installing rooftop panels. Through community solar, customers have access to renewable energy and savings without needing to invest in rooftop solar.

### Credit Score Requirements for Community Shared Solar

Community solar has the potential to expand renewable energy access to a much wider demographic than rooftop solar. However, the community solar market is still developing and thus is subject to considerable uncertainty within the financial community. In many cases, financiers require that solar developers vet customer credit scores in order to mitigate perceived subscription payment risk. Consequently, developers may require a minimum score of 700 on the FICO scale. These high credit requirements exclude a significant portion of the population.

In particular, the direct correlation between credit scores and income results in the disproportionate exclusion of LMI households from the community solar market. See Feinstein, Alternative data and fair lending, Technical report, New York N.Y., 2013 (“Feinstein report”). Credit scores are developed for consumers actively participating in the banking and credit system, which naturally favors higher-income consumers. While the exact formulas for calculating credit scores are industry secrets, the score is determined based on five categories of information: 1) payment history, 2) utilization ratio (the amount owed versus the individual's maximum credit limit), 3) length of credit history, 4) recent activity, and 5) how much debt remains unpaid. See Smith, How is your credit score determined?, available at https://www.experian.com/blogs/ask-experian/how-is-your-credit-score-determined/, August 2016. Data for each of these categories are collected from a variety of types of credit, including mortgages, credit cards, auto loans, student loans, etc. A lack of ability to engage with these systems leads to credit scores that are often inadequate to participate in community solar. For example, 56% of American consumers have subprime credit scores and thus would not qualify for a community solar program where qualification is based on credit score. See Brooks et al., Excluded from the Financial Mainstream: How the Economic Recovery is Bypassing Millions of Americans. CED, Washington. D.C., 5 edition, 2015.

Furthermore, while some individuals are excluded from mainstream credit because their credit score is too low, other individuals are denied access because their credit score is nonexistent. In order to investigate groups excluded from mainstream credit, the Consumer Financial Protection Bureau has defined the terms credit invisibles and credit unscorables; credit invisibles include individuals without any records with national credit rating agencies, and unscorables include those with thin credit files or stale records. See CFPB report. The same organization estimates that in 2010, 26 million Americans were credit invisible while an additional 19.4 million were unscorable. See CFPB report.

Individuals from LMI households are also disproportionately more likely to be unscored than their wealthier counterparts. Nearly 50% of low-income consumers and 30% of moderate income consumers are unscored, compared to only 10% of upper income consumers. See CFPB report. Lenders generally consider consumers without credit scores to be high risk. See Feinstein report. The exclusion of LMI households is particularly impactful as these households stand to benefit the most from a subscription-model community utility service such as community solar. A 2016 report cited that the median energy burden for households with less than 80% of their area median income was 7.2%, while non low-income households had a median energy burden of 2.3%. See Drehobl report. In other words, the energy burden among LMI households is disproportionately higher than the total population. LMI households could be included in community-solar projects without additional risk to the investors of these developments.

### Utility Bills as Proxies for Community Shared Solar Payments

It was hypothesized that FICO scores and other traditional credit score indicators are an imperfect predictor of community solar service payments, and that utility payment history would better predict the risk of community solar payment default. The present invention uses utility payment history rather than community solar subscription payment history for several reasons. Because the market for community utility programs is still developing, there are limited historical data on community solar payments. There is also inherent selection bias in the existing data. The selection bias stems from the existing high FICO requirements that make it impossible to assess repayment rates of households with lower FICO scores. Therefore, utility payment history was used as a proxy for community solar subscription payments.

It was also hypothesized that utility and community solar payments will be adequate proxies for one another. Community solar payments and utility payments are generally similar in amounts. In addition, energy spending is a necessary good for most consumers, such that it tends be among the first household expenses to be paid. Based on status quo bias, it was hypothesized that customer prioritization of electric utility bills would extend to community solar energy bills.

Another reason to use utility payment history as a proxy for community solar is the potential for bill consolidation. A few states with emerging community solar markets are considering legislation that would consolidate utility and community solar subscription bills. If community solar charges appear on a customer's utility bill, then consumers may treat utility bills and community solar bills similarly. Therefore, bill consolidation further supports a close proxy relationship between community solar subscription payments and electric utility bill payments.

### Alternative Credit Metrics in Industry

Alternative credit scoring mechanisms would provide value in other industries as well, such as student loans, vehicle purchases, mortgage applications, credit card applications, and a number of other industries which rely on the existing FICO credit score. Incorporating alternative data can generate credit scores for those individuals currently without scores. For example, LexisNexis has developed the RiskView Score, an alternative credit metric, which scored nearly 10% of the sample that did not have a score previously. See Schneider et al., The predictive value of alternative credit scores, available at https://finhealthnetwork.org/research/the-predictive-value-of-alternative-credit-scores/, November 2007 (“Schneider et al.”). Another alternative credit metric, Link2Credit, created scores for 19 million previously unscored records. In 2012, the Policy and Economic Research Council (PERC) conducted a study on the impact of alternative data on credit scores using both non-financial tradeline data and utility data. The study found that 74% of sampled customers that were previously unscorable could be scored using alternative data. See Turner et al., A new pathway to financial inclusion: Alternative data, credit building, and responsible lending in the wake of the great recession, Technical report, Durham, N.C., 2012. Alternative data can therefore create a creditworthiness metric to extend credit to individuals without scores.

In addition to creating scores for the unscored, alternative data increases the efficacy and precision of traditional credit scoring. The RiskView Score improved the segmentation of consumers within credit ranges, allowing for expanded and more precise lending. LexisNexis used a cross section of traditional credit scores and the RiskView Score to determine which consumers within each range of credit scores were higher risk borrowers than others. See Feinstein report; Schneider et al. Alternative data improves the precision with which credit rating agencies can measure creditworthiness, which in turn can extend credit beyond traditional scoring boundaries without negatively impacting bill payment rates. A 2015 PERC study found that non-financial utility and telecom delinquencies were predictive of future mortgage, bank card, and public record delinquencies. See Turner et al., Predicting financial account delinquencies with utility and telecom payment data, Technical report, Durham, N.C., 2015. Empirically, alternative data has successfully predicted financial default.

Several national credit agencies have created products using alternative data. The aforementioned Link2Credit score uses phone payment history and other public record metrics, while Fair Isaac developed a FICO expansion score including debit data, utility data, and public record attributes. See Schneider et al. Equifax marketed their Advanced Energy Plus score to use energy payment data to augment thin file consumers' credit history. Alternative credit metrics are more useful if they are widely trusted and usable in the finance community. While the array of alternative credit products does not signify widespread use, it signals market interest and credibility of such products.

### Alternative Credit Metrics in Academia

In addition to the industry-led initiatives, there has been other research in academia exploring alternative credit scoring mechanisms for various purposes. There has been literature that uses regression discontinuity to display the moral hazard effect induced when private lenders employ strict FICO Score cutoffs. See Jiang et al., Securitization and loan performance: Ex ante and ex post relations in the mortgage market, The Review of Financial Studies, 27(2):454-483, 2013; Keys et al., Financial regulation and securitization: Evidence from subprime loans, Journal of Monetary Economics, 56(5):700-720, 2009; Keys et al., Lender screening and the role of securitization: evidence from prime and subprime mortgage markets, The Review of Financial Studies, 25(7):2071-2108, 2012; Krainer et al., Mortgage loan securitization and relative loan performance, Journal of Financial Services Research, 45(1):39-66, 2014; Rajan et al., The failure of models that predict failure: Distance, incentives and defaults. Journal of Financial Economics, 115(2):237-260, 2015. In other words, private lenders are more likely to offer services to customers with a FICO score just above a certain threshold than they are to customers below the same threshold. In an analysis of subprime mortgage loan contracts in the United States, Keys et al. show that such securitization practices adversely affect the incentives for lenders to carefully screen borrowers. See Keys et al., Did securitization lead to lax screening? Evidence from subprime loans. The Quarterly Journal of Economics, 125(1):307-362, 2010.

To address the issue, a number of researchers and academics have used statistics and machine learning to provide an alternative credit scoring mechanism. Nikravesh used fuzzy query and ranking as a method of predicting the default risk associated with lending to a new customer, and to serve as an alternative to the FICO score. Nikravesh, Credit scoring for billions of financing decisions. Proceedings Joint 9th IFSA World Congress and 20th NAFIPS International Conference, vol. 1, pages 191-196. July 2001. Yu et al. proposed a multistage neural network ensemble learning model to predict credit risk. Yu et al., Credit risk assessment with a multistage neural network ensemble learning approach. Expert Systems with Applications, 34(2):1434-1444, 2008. Huang et al. investigated a data mining approach with support vector machines as a credit scoring model, which required a long training time. Huang et al., Credit scoring with a data mining approach based on support vector machines. Expert Systems with Applications, 33(4):847-856, 2007. Wang et al. experimented with fuzzy SVMs and traditional SVMs for predicting credit risk to show that the fuzzy SVM achieves better generalizability by being less sensitive to outliers than alternative machine learning methods. Wang et al., A new fuzzy support vector machine to evaluate credit risk. IEEE Transactions on Fuzzy Systems, 13(6):820-831, 2005. Antonakis et al. analyzed the predictive ability of several machine learning approaches, including Naïve Bayes Rule, k-Nearest Neighbors, classification trees, and neural networks, for screening credit applicants. Antonakis et al., Assessing naïve bayes as a method for screening credit applicants. Journal of Applied Statistics, 36(5):537-545, 2009. Khandani et al. used generalized classification and regression trees to classify the rates of credit-card holder delinquencies and defaults, and used their results to study nonlinear relationships that are not captured by traditional credit scores. Khandani et al., Consumer credit-risk models via machine-learning algorithms. Journal of Banking Finance, 34(11):2767-2787, 2010. Wang et al. demonstrated the feasibility of using bagging and random subspace, together with Support Vector Machines, as an alternative method to predict credit risk assessment. Wang et al. A comparative assessment of ensemble learning for credit scoring, Expert Systems with Applications, 28(1):223-230, 2011; Wang et al., A hybrid ensemble approach for enterprise credit risk assessment based on support vector machine, Expert Systems with Applications, 39(5):5325-5331, 2012. Wang et al. also compared the predictive ability of logistic regression analysis (LRA), linear discriminant analysis (LDA), multi-layer perceptron (MLP), and radial basis function network (RBFN), with decision trees with and without bagging as alternative methods of credit scoring. Wang et al., Two credit scoring models based on dual strategy ensemble trees. Knowledge-Based Systems, 26:61-68, 2012. The decision tree models explored by Wang et al. demonstrated some of the lowest performance ratings due to noise; in contrast, the decision tree predictive model according to a preferred embodiment of the present invention—a random forest model—was found to be the most accurate of the tested methods. Finally, Kruppa et al. demonstrated the accuracy of random forest, k-Nearest Neighbors, and bagged k-Nearest Neighbors to predict consumer credit risks in the context of installment payments for household appliances. Kruppa et al., Consumer credit risk: Individual probability estimates using machine learning. Expert Systems with Applications, 40(13):5125-5131, 2013. This research into using machine learning techniques to assess credit risk has not applied machine learning to assess default risk for community utility service bill payment, nor has it identified the impacts of such alternative risk assessment for lower-income customers or on the utility (e.g., community solar) industry.

Embodiments of the present invention employ methods for assessing probability of delinquency on utility bill payment that offer improved alternatives to using FICO score. In certain embodiments, the invention employs a predictive machine learning model such as a random forest model. For example, the predictive machine learning model can be a model that is trained, tested, and validated using a data set associated with account-level credit score and monthly payment performance over a specific duration from a credit reporting agency, alone or in combination with other financial and demographic data.

Further details of using methods, such as random forest machine learning to predict probability of delinquency, are described in the following examples. The examples serve only to illustrate the invention and its practice. The examples are not to be construed as limitations on the scope or spirit of the invention.

### Example 1—Data

### Data Collection

Embodiments of the present invention use a predictive machine learning model that is trained, tested, and validated using a data set associated with account-level credit score and monthly payment performance over a statistically significant duration from a credit reporting agency, alone or in combination with other financial and demographic data.

In certain embodiments, a predictive machine learning model is used to predict an individual's probability of delinquency on a utility bill payment. The model is a predictive model that was trained, tested, and validated using a data set associated with account-level credit score and monthly payment performance between December 2009 and November 2016, obtained from a credit reporting agency (CRA), along with other financial and demographic data. Records with at least 24 months of consecutive utility payment performance data in the period (December 2014 to November 2016) were used, as one goal was to predict payment performance in the last 12 months of the data.

The full universe of data from the CRA included 8.3 million records, of which 10.6% (872,382) had 24 consecutive months of payment history for an individual utility account. Of those individual utility account holders with a full history, 61.1% (535,931) had no negative record and 38.9% (341,372) had at least one negative record. A negative record was defined to be any delinquency of at least 30 days. Because utilities typically are likely to report a delinquent account, such accounts may be over-represented in the set of accounts with 24 months of consecutive payment data. Since access to the full universe of CRA data was unavailable, a sample was constructed requiring 36 months of data to illustrate the effect of restricting the data in this manner to require 24 months of data. The sample was constructed based on the assumption that moving from an unrestricted sample to the sample requiring 24 months of data has a similar effect as moving from the sample requiring 24 months of data to an even more restrictive sample requiring 36 months of data.

In addition to payment history, demographic data, including features such as home ownership, length of residence, level of education, and age, were collected.

### Descriptive Statistics of Data Set Used in Exemplary Embodiments

In order to assess whether the sample differs demographically from the U.S. population, the sample was compared to national averages from the Census. As shown in Table 1, the sample is more or less representative of the U.S. population in terms of annual income, but under-represents women and minorities. However, utility account holders (who in many instances will be one member from a household) will most likely differ from the entire U.S. population.

TABLE 1
Descriptive statistics: demographic variables

| | Testing sample | US average |
|---|---|---|
| Income (median) | $55,000-$59,999 | $55.322 |
| College | 19.3% | 30.3% |
| Female | 26.6% | 50.8% |
| Black | 10.5% | 13.3% |
| Hispanic | 8.4% | 17.8% |

Looking across geographies as shown in Table 2, a few observations bear mentioning. First, urban, suburban, and rural households are all well-represented in the sample. Looking across regions, however, the majority of observations come from the East North Central region (82.6%). Most of these observations are from Wisconsin (74.1%), although this percentage is of the 64.3% of the sample that report the state of residence. This percentage of Wisconsinites would affect the accuracy of the alternative scoring mechanisms only if Wisconsinites systematically differ from the rest of the country in terms of the relationship between past and future payment performance. However, Table 4 below shows that the accuracy of the alternative scoring mechanisms marginally increases when running the analysis on a sample excluding Wisconsin, indicating that the proportionally high representation of Wisconsinites does not raise a concern as to the validity of the study data.

TABLE 2
Geographical statistics for data set used in exemplary embodiment

| | |
|---|---|
| % | N |

Population density

| | | |
|---|---|---|
| Rural areas | 26.9 | 234,181 |
| Smaller suburbs and towns | 38.5 | 335,960 |
| City and surrounds | 34.6 | 302,047 |

Census division

| | | |
|---|---|---|
| New England | 2.6 | 14,710 |
| Middle Atlantic | 2.6 | 14,309 |
| East North Central | 82.6 | 463,04 |
| West North Central | 0.9 | 4,992 |
| South Atlantic | 8.3 | 46,367 |
| East South Central | 0.7 | 3,814 |
| West South Central | 0.3 | 1,626 |
| Mountain | 0.6 | 3,557 |
| Pacific | 1.5 | 8,314 |

State

| | % | N | | % | N |
|---|---|---|---|---|---|
| Alabama | 0.2 | 915 | Montana | 0.0 | 47 |
| Alaska | 0.0 | 35 | Nebraska | 0.1 | 292 |
| Arizona | 0.2 | 918 | Nevada | 0.1 | 405 |
| Arkansas | 0.0 | 117 | New Hampshire | 0.0 | 90 |
| California | 0.3 | 1,640 | New Jersey | 0.1 | 560 |
| Colorado | 0.1 | 435 | New Mexico | 0.1 | 738 |
| Connecticut | 2.5 | 13,942 | New York | 1.7 | 9,505 |
| Delaware | 0.0 | 99 | North Carolina | 0.9 | 5,201 |
| District of Columbia | 0.0 | 66 | North Dakota | 0.0 | 23 |
| Florida | 0.8 | 4,201 | Ohio | 1.3 | 7,266 |
| Georgia | 0.7 | 4,175 | Oklahoma | 0.0 | 126 |
| Hawaii | 0.0 | 49 | Oregon | 0.4 | 2,331 |
| Idaho | 0.2 | 878 | Pennsylvania | 0.8 | 4,244 |
| Illinois | 2.2 | 12,463 | Rhode Island | 0.0 | 112 |
| Indiana | 2.0 | 11,162 | South Carolina | 4.1 | 23,197 |
| Iowa | 0.1 | 725 | South Dakota | 0.0 | 12 |
| Kansas | 0.0 | 78 | Tennessee | 0.4 | 2,255 |
| Kentucky | 0.1 | 315 | Texas | 0.2 | 1,209 |
| Louisiana | 0.0 | 174 | Utah | 0.0 | 109 |
| Maine | 0.0 | 73 | Vermont | 0.0 | 52 |
| Maryland | 0.1 | 650 | Virginia | 0.2 | 909 |
| Massachusetts | 0.1 | 441 | Washington | 0.8 | 4,259 |
| Michigan | 3.0 | 16,680 | West Virginia | 1.4 | 7,869 |
| Minnesota | 0.6 | 3,536 | Wisconsin | 74.1 | 415,473 |
| Mississippi | 0.1 | 329 | Wyoming | 0.0 | 27 |
| Missouri | 0.1 | 296 | | | |

### Data Processing

For an exemplary predictive machine learning model according to the present invention, the data set used for training, validating, and testing included 872,382 individual records and 5,022 variables. The entire data set was used to improve the accuracy of the model and to classify all of the records in the data set. Three main processing or data cleaning steps were employed before analyzing the data. First, the order of the samples in the data set was randomized by shuffling the rows. Second, since the machine learning algorithms require there to be no missing values, each variable with a missing value was given the value zero and a corresponding indicator variable was generated for each variable; this corresponding indicator variable took the value 1 if the value for the variable was missing. Variables with existing numeric missing-value codes (e.g. FICO score) were included in this process.

The full data set was then divided into a training data set, a validation data set, and a testing data set, containing 60%, 20%, and 20% of the data, respectively. The same data sets were used for all of the models in order to appropriately compare the accuracy rates among models. For the traditional regression analysis (for which there is no need for a validation data set), the training and validation data sets were combined to produce the models.

### Example 2—an Alternative Scoring Mechanism

Described herein is a process for developing predictive models to evaluate customers for enrollment in a community shared utility service (for example, community shared solar), by leveraging the rich data set of individual utility account holders. The predictive models offer improved alternatives to using traditional credit scores.

A number of alternative models were developed, using the twelve months of data prior to December 2015 to predict the likelihood of being delinquent at least once in the following 12-month period (December 2015 to November 2016). The models varied on two dimensions. First, the models varied on the basis of using traditional regression analysis, or machine learning techniques. Second, the models varied with respect to the definition of a delinquency used as the dependent variable, from non-payment of a utility bill for greater than 30 days, to non-payment of a utility bill for greater than 90 days.

### Traditional Regression Analysis

The performance of a set of models was estimated using a small number of variables, (in certain embodiments, 10 variables), that were deemed to be the most relevant for predicting the probability of being delinquent in a given 12-month period. Using a traditional regression method may present an improvement for evaluating candidates for potential enrollment in a community shared utility service (e.g., community shared solar) over using FICO score alone. Specifically, the regression model is designed to predict the probability of delinquency in utility payments. In contrast, FICO scoring evaluates more general financial habits, and thus may factor in many other variables not directly relevant for utility payment performance such as credit card debt and installment loans.

In particular, the present methods estimate linear probability and probit models of the form:

Pr(Dᵢₜ)=o+γ₁Dᵢₜ₋₁⁸⁰+γ₂Dᵢₜ₋₁⁶⁰+γ₃Dᵢₜ₋₁⁹⁰+γ₄FICOᵢₜ₋₁+γ₅noFICOᵢₜ₋₁+X′ᵢₜβ (1),

where Pr(Dᵢₜ) is the probability of at least one delinquency for individual i in the 12-month period using the 30-day, 60-day, or 90-day definition depending on the embodiment. The various D^{j}ᵢₜ₋₁ variables are indicator variables for at least one delinquency of more than j days for the individual in the previous 12-month period. FICO and noFICO represent the individual's FICO score and an indicator variable equal to one if that individual does not have a FICO score. The matrix X contains variables for demographic and housing characteristics, which in the embodiment presented in Table 9 include binary variables for new movers (within the past twelve months), home ownership, and residence in a multifamily building. A number of other specifications were estimated, including those with the following demographic characteristics in addition to the aforementioned: a binary variable for college education and a categorical variable for income in $10K increments up to $120K+. These variables only marginally increased the R-squared of the model (i.e., the coefficient of determination, or goodness-of-fit for the model with respect to the actual data) while adding in variables that are at odds with the LMI inclusion goal. The full set of specifications are presented in the Tables 8 and 9.

TABLE 3
Regression models of probability of delinquency with limited variables
and varying delinquency definitions

| | NotCurrent | | >90DaysPastDue | |
|---|---|---|---|---|
| | LPM | Probit | LPM | Probit |
| Regressor | (1) | (2) | (3) | (4) |
| FICO | −0.00105*** | −0.00279*** | −0.00139*** | −0.00828*** |
| | (5.49e−06) | (2.51e−05) | (4.27e−06) | (4.00e−05) |
| FICOBlank | −0.574*** | −1.316*** | −0.723*** | −4.237*** |
| | (0.00338) | (0.0213) | (0.00291) | (0.0274) |
| 30DaysPastDue | 0.147*** | 1.483*** | 0.479*** | 2.209*** |
| | (0.00122) | (0.0172) | (0.00196) | (0.0121) |
| 60DaysPastDue | −0.00688*** | 0.104*** | −0.110*** | −0.0498*** |
| | (0.00124) | (0.0130) | (0.00204) | (0.0107) |
| >90DaysPastDue | 0.0886*** | 0.891*** | 0.421*** | 1.664*** |
| | (0.00101) | (0.00941) | (0.00128) | (0.00831) |
| NewMover | 0.0394*** | 0.129*** | −0.00324 | −0.0176 |
| | (0.00427) | (0.0156) | (0.00246) | (0.0257) |
| HomeOwner | −0.0479*** | −0.290*** | −0.0358*** | −0.205*** |
| | (0.00102) | (0.00624) | (0.000912) | (0.00694) |
| Multifamily | 0.0809*** | 0.362*** | −0.0171*** | −0.0872*** |
| | (0.00130) | (0.00702) | (0.000992) | (0.00823) |
| Constant | 1.415*** | 2.544*** | 1.138*** | 4.154*** |
| | (0.00384) | (0.0190) | (0.00330) | (0.0264) |
| N | 697,762 | 697,762 | 697,762 | 697,762 |
| R² | 0.204 | 0.233 | 0.758 | 0.754 |

Robust standard errors in parentheses (***p < 0.01, **p < 0.05, *p < 0.1). All specifications also include indicator variables for missing demographic variables (NewMover, HomeOwner, Multifamily).

The regression models are presented in Table 10 using a 30-day definition for delinquency in columns (1) and (2), and a 90-day definition in columns (3) and (4), using both linear probability model (LPM) and probit specifications. For the probit models, the table reports the marginal effects at the means of continuous variables, and for binary variables the table reports the average effect of moving from 0 to 1. The variables for days past due indicate whether, at any point in the past 12 months, the account was 30, 60, or over 90 days past due (these variables are not mutually exclusive).

The coefficients on FICO score are negative and highly significant across specifications. Looking at the linear probability models, all else held constant, a 10-point decrease in a FICO score would increase the probability of an account being 30 and over 90 days past due by 1.1 and 1.4%, respectively. Interestingly, however, having no FICO score seems to have a negative effect on the likelihood of being delinquent (a positive effect on payment performance). One plausible explanation is that individuals with poor payment performance and with no credit score already have their risk captured by the three delinquency variables, which are, for the most part negative and highly significant.

Interestingly, using the less strict 90-day definition for delinquency as the dependent variable captures a much greater share of the variation than the 30-day definition (75.8% versus 20.4%). This result is likely due to the fact that 30-day delinquencies are a much noisier measure of financial habits than delinquencies of greater than 90 days. For instance, a 30-day delinquency could be due to a one-time error such as a misplaced envelope, whereas a 90-day delinquency is more likely to be an indicator of being a risky consumer. This reasoning is consistent with the fact that being a new mover has a statistically significant effect only in the 30-day models.

### Machine Learning Techniques

Records were classified using several different exemplary machine learning techniques in order to compare the performances of each technique. First, different machine learning algorithms were applied to a smaller data set, as described below. Since there are both continuous and categorical variables, it is important to normalize the data. Three different normalization techniques were tried in order to find the technique that provided the best fit. Dimensional reduction was then performed on the entire data set to prioritize the important features and create a condensed data set. Using the condensed data set, several different machine learning techniques, such as least absolute shrinkage and selection operator (LASSO), support vector machines (SVMs), and a random forest algorithm, were tested.

### Creating Architectures on a Subset

In developing predictive machine learning models according to the present invention, a subset of 10,000 samples (individuals) and 13 features were used to build the models. Using samples from the whole data set instead of the entire data set allowed more rapid conducting of the tests. The entire data set was incorporated after the methodology was perfected.

In order to obtain a high level of accuracy, the data were normalized using the following min-max feature scaling equation:

$${x}^{′} = \frac{x - {x}_{min}}{{x}_{max} - {x}_{min}} , \qquad ( 2 )$$

This type of normalization yielded better accuracy, as it gives only non-negative values; it also demonstrated the highest accuracy on the linear regressions, relative to the following alternatives:

$${x}^{′} = \frac{x - μ}{σ} , \qquad ( 3 )$$

$${x}^{′} = \frac{x - μ}{{x}_{max} - {x}_{min}} . \qquad ( 4 )$$

### Dimensional Reduction Using LASSO

To compare the predictive machine learning models and reduce computing times, dimensional reduction was performed on the large data set to identify the important features and use the most significant variables. While some of the demographic variables hold economic significance (e.g. home market value, income code, and number of cars owned), other variables were determined to be extraneous and unnecessary for the analysis (e.g. whether the individual was a movie collector, type of preferred vacation, and women's suit size). Removing these parameters increased the computing time, maintained relevance of the parameters, and increased accuracy of the model; it also decreased the data requirements for the alternative scoring method. Least absolute shrinkage and selection operator (LASSO) was used for feature selection and as a shrinkage method, to reduce the size of the dataset used to train the model, identify the most important features, and use them to conduct the rest of the analysis. See Yu et al., Credit risk assessment with a multistage neural network ensemble learning approach. Expert Systems with Applications, 34(2):1434-1444, 2008. LASSO was performed on the entire data set using remote computing, with a λ=0.05, yielding twenty important features. The most important features were the delinquency in the previous time period, values from the payment grid, and the amount past due. The top five variables and their respective weights are displayed in Table 4 below.

TABLE 4
Weights for five most important variables

| | | Absolute |
|---|---|---|
| | | Value of |
| Var Name | Meaning | Weight |
| CURR KEYCD 24 | Current on Utility Payments in | 0.3577 |
| | previous year | |
| PAYMENT GRID81 | Payment history grid | 0.0359 |
| ACCT PAST DUE | Amount Past Due | 0.0292 |
| DELQ DT 1 BLANK | Most recent delinquency date | 0.024654 |
| | unavailable | |
| DELQT DT 2 BLANK | Second most recent delinquency | 0.008477 |
| | date unavailable | |

In developing the exemplary predictive models in accordance with the present invention, employing these variables was determined to be useful in calculating the probability of delinquency for an individual account holder. While some of the most important features included delinquency in the last year and FICO score, other financial data was also found to be important. In particular, the top 20 features included features relating to financial payment history. However, none of the top 20 features were demographic variables.

### Support Vector Machines

Support Vector Machines (SVMs) are a method of supervised machine learning that uses labeled training data to formulate the optimal hyperplane that can classify new data points. See Patel, Chapter 2: Svm (support vector machine)—theory, available at medium, com/machine-learning-101/chapter-2-svm-support-vector-machine-theory-f0812effc72, May, 2017. SVMs create decision boundaries between different labels (in this case, delinquent and not delinquent) in high dimensional spaces. See 1.4, support vector machines, available at scikit-learn.org/stable/modules/svm.html. This means that if there is no clear decision boundary in a two-dimensional place, SVMs can extrapolate to higher dimensions to create a hyperplane that can be used to classify various data points. The dual form of linear SVMs is specified below, where xᵢ represents the input parameters, yᵢ is the decision variable, and αᵢ is the dual variable and related to the weight vector.

$${max}_{α} - \frac{1}{2} {‖ {\sum }_{i} {α}_{i} {y}_{i} {x}_{i} ‖}^{2} + {\sum }_{i} {α}_{i} , \qquad ( 5 )$$

$${\sum }_{i} {y}_{i} {α}_{i} = 0 , \qquad ( 6 )$$

$$0 \leq α \leq C . \qquad ( 7 )$$

The algorithm will perform certain transformations on the data points, known as kernels, to translate it into higher dimensions. Kernels are useful tools to express complicated feature functions in a simple way. Beyond the linear kernel, the Gaussian radial basis function (rbf) kernel is a popular kernel function. The Gaussian RBF kernel, which is stated in Equation 8, has special properties that allow it to classify correctly almost all of the time.

K(x,x′)=exp(−γ∥x−x′∥²) (8)

However, one must be wary of overfitting when using the Gaussian RBF Kernel. A regularization term, C, is added to prevent overfitting and accommodate cases when the data are linearly inseparable. The regularization parameter represents the importance of the training errors. As the regularization parameter, C, increases, the margin width becomes smaller, and therefore there are less margin violations. An increase in the regularization term correlates with a greater emphasis on margin violations, and the margin becomes tighter around the decision boundary. Thus, the number of support vectors, and violations, decreases as C increases. However, it is imperative to consider the tradeoff between accuracy and robustness, as it is important to prevent the algorithm from overfitting to the training data.

The γ term reflects a certain margin of error surrounding the decision boundary. A small gamma corresponds to a decision boundary that underfits the data, while, a larger gamma value tends to overfit the data.

The hyperparameters, C, γ, and the kernel type, were tuned on the validation data set. The SVM used has the following specifications: C=10, γ=0.1, and it utilizes a radial basis function (rbf) kernel. While this SVM method for developing a predictive model displays high accuracy rates, it is very time consuming, and computing time is an important factor when comparing it to other methods.

TABLE 5
Accuracy rates for machine learning models with different definitions
of delinquency

| | Not Current | | >90 Days Past Due | |
|---|---|---|---|---|
| | Training | Testing | Training | Testing |
| | Accuracy | Accuracy | Accuracy | Accuracy |
| ML Method | (1) | (2) | (3) | (4) |
| LASSO | 91.14% | 90.37% | 96.26% | 96.05% |
| SVM | 94.44% | 89.71% | 99.02% | 87.82% |
| Random Forest Algorithm | 100% | 97.49% | 100% | 98.99% |
| Random Forest without WI | 100% | 97.85% | 100% | 99.05% |

### Random Forest Algorithm

The random forest algorithm, another supervised machine learning technique, was also examined. The random forest technique involves separating the training and validation data set into multiple smaller datasets, or bags, forming decision trees with the smaller data sets, and using the many decision trees to classify the input parameters, as further described below.

Since it uses decision trees, the random forest algorithm is particularly appropriate for this application due to the fact that the dataset includes many variables (also known as features) of varying importance, on different scales. Decision trees are useful for finding the appropriate feature to split on, and for finding the value of that feature in order to minimize the cost function. See Jones et al., Exploratory data analysis using random forests, available at https://cran.r-project.org/web/packages/edarf/vignettes/edarf.html. A greedy heuristic model, which locally minimizes the cost in order to find the global optimum, was used.

Given the large amount of data used in this study, bagging, or the bootstrap algorithm, was determined to be the best way to improve accuracy rates while preventing overfitting the data set. Bagging essentially means that the algorithm takes random samples, creates several different classifiers, and uses the errors from one classifier to ‘learn’ from its mistakes and create future classifiers. The random forest algorithm creates many random samples (many decision trees) and essentially averages the outcome overall of the decision trees to provide one final answer. The learning implementation of random forests of Scikit-learn (also known as SkLearn) was used to label records using this technique, and to predict the probabilities of delinquency and non-delinquency. The depth of each tree can be limited to be no more than 150 levels. For example, the depth of each tree was limited to 100 levels, and the seed of the forests was predetermined to 27. Table 5 provides the results.

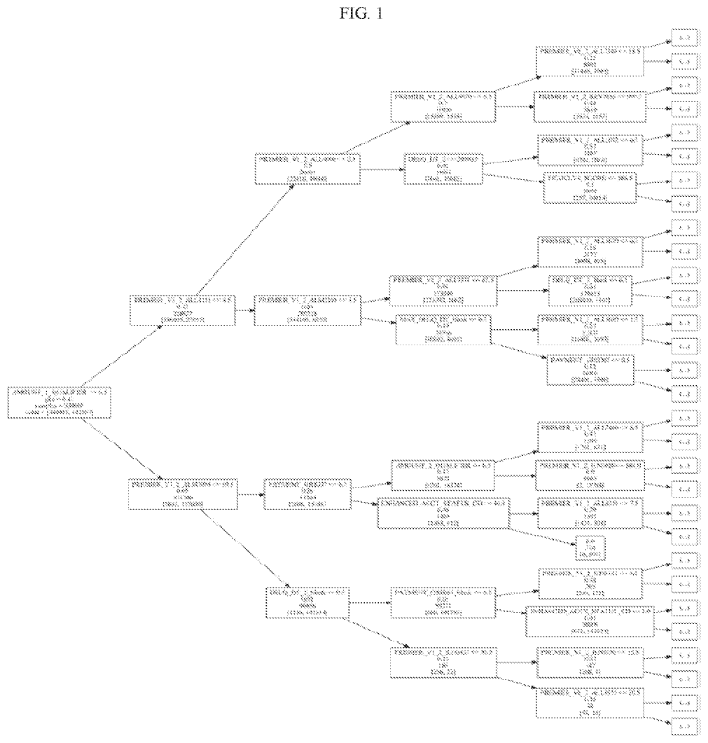

FIG. 1 shows a visual representation of the random forest algorithm, focusing on one of the decision trees in order to visualize how the architecture works. The entire random forest is very large and has many branches and nodes. However this visualization shows how some variables specifically affect the labelling, which could be useful for further applications.

Not only are decision trees accurate, they have a relatively short running time. Not all of the features have the same level of importance for the model; the decision tree can distinguish which features are important, and rank them in order of importance. While other models mainly consider linear or non-linear combinations of the features, the decision tree algorithm is able to solve the best splitting criteria: this may be a binary split, a specific threshold, a quadratic term, or another non-linear representation of a feature. It is particularly efficient here as, on the one hand, it accounts for highly non-linear combination and gives interpretability, and on the other hand, it does not require dimensionality reduction, which is a time-consuming process.

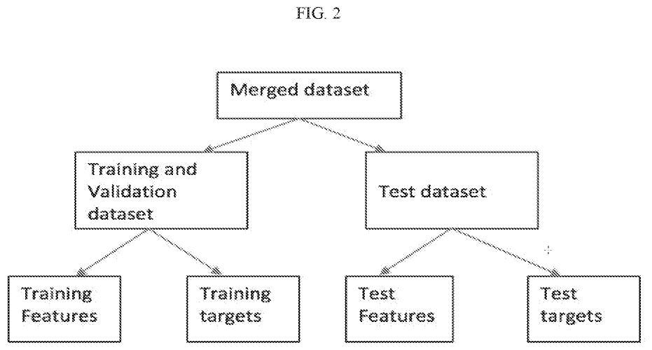

The following description provides details of this model, as used to predict delinquency at 90 days. The data on over 800,000 individuals were merged. The merged dataset was then split into a training dataset (which also serves as the validation set) and a test dataset using Scikit-learn's train_test_split model, with random_state set at 27. Each of the training dataset and test dataset was then split into two further datasets, as shown in FIG. 2: “features” (independent variables, which included all variables except for Delinquent at 90 days) and “target” (the dependent variable, which in this case was Delinquent at 90 days). Unique identifiers were then dropped from the features and target to prevent the random forest classifier from including them in the analysis.

A random forest classifier was defined with the following parameters in order to fit the data:

(a) n_estimators=150: this parameter is the number of trees in the assumed forest. Currently, by default, Scikit-learn sets the number of trees to be from 10 to 100. The higher the number of trees, the better the model is able to learn from the data. However, using a higher number of trees (setting the n_estimators parameter to a higher number) can slow down the training process.

(b) max_depth=100: this parameter determines the maximum number of features to consider while looking for a split. As the depth of a tree increases, it requires more information to make a decision. The mar_depth parameter is specified in order to prevent overfitting. This parameter represents how many questions are asked before the predicted classification is reached—e.g., was customer delinquent for at least 30 days? [yes|no], was customer delinquent for 30 to 60 days? [yes|no], was customer delinquent for 60 to 90 days? [yes|no] and finally reaching the classification point: was customer delinquent for at least 90 days? [yes|no].

(c) random_state=27: this parameter sets a seed to the random generator, so that training results are always deterministic. If no seed is set, the outcomes can be different each time.

The defined classifier was fit to the defined formula and finally, the model was created and trained based on the fit classifier formula using the training features and training targets. The result from the training process is the predictive model. This predictive model was tested for accuracy by applying it to the Test Features dataset, where it predicted the possible outcomes (if a customer was delinquent at 90 days or not) using Scikit-learn's “predict” module. The results were then compared with the Test Targets dataset. Approximately 99% of the predictions made by the predictive model trained according to the random forest classification process were same as the actual data in the Test Targets dataset.

The top 100 variables obtained for this random forest-based predictive model are shown in Table 11.

For future predictions (for delinquency at 90 days) to be conducted, a separate python jupyter notebook was created using the following steps:
(1) Required libraries including pandas, numpy, Scikit-learn and pickle, all associated with the open source python jupyter notebook, were imported.
(2) A variable name was created to take in data for scoring.
(3) The data would be read using pandas, which would also drop the delinquent at 90 days and unique identifying numbers features, and replace all missing values with zeros.
(4) The dataset would then be converted from pandas to numpy array format.
(5) The saved EnergyScore pickle file would be opened using pickle library. Then, the dataset to be scored is passed through the opened EnergyScore pickle file.
(6) Finally, using Scikit-learn's “predict_proba” module, the EnergyScore pickle file would predict the probabilities of delinquency for 90 days, and of non-delinquency for 90 days, and output the probabilities in a CSV file format.

### SUMMARY

Among the variety of models explored, the random forest algorithm was superior in terms of accuracy. The random forest algorithm exhibited better accuracy while also requiring less data pre-processing. The results from the random forest model are easier to interpret, and the model runs more quickly. These advantages make a random forest architecture a preferred scoring mechanism, and an improvement over the FICO score and other techniques.

### Results

The alternative scoring methods developed with traditional regression analysis and machine learning techniques were compared to standard FICO cutoffs, in terms of accuracy, default rate, and LMI inclusion.

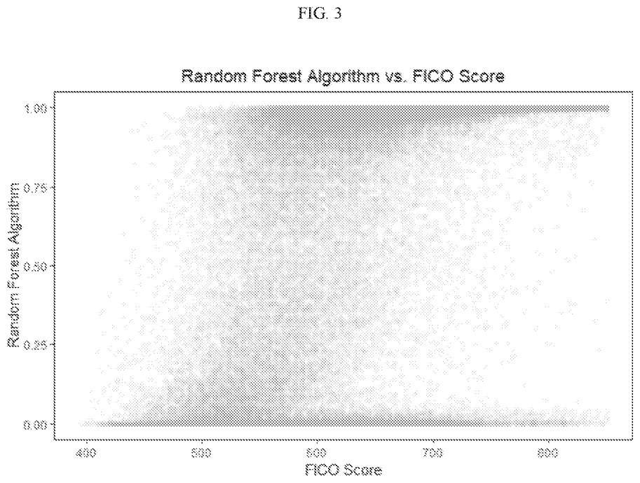

FIG. 3 displays the probabilities of non-delinquency using the random forest algorithm against the individual's FICO Score. As shown, there are many individuals who have a high probability of non-delinquency with the random forest algorithm, but do not have a very high FICO score. This comparison demonstrates the number of people who would have been rejected with the FICO cutoff, but accepted according to the random forest algorithm (“false negatives”). Additionally, there are quite a few data points with high FICO scores but do not have a high probability with the random forest algorithm, who would be erroneously accepted (“false positives”). FIG. 3 suggests that the traditional FICO scoring cutoff, as a method for qualifying potential customers for a shared utility service, produces high numbers of both false negatives and false positives. While the FICO Score itself constitutes one variable used by the random forest algorithm, there are many other variables as well. In order to further render the random forest algorithm comparable to the FICO score, the share of the sample approved under all possible FICO cutoffs was computed the FICO scoring method was compared to an equivalently selective random forest algorithm.

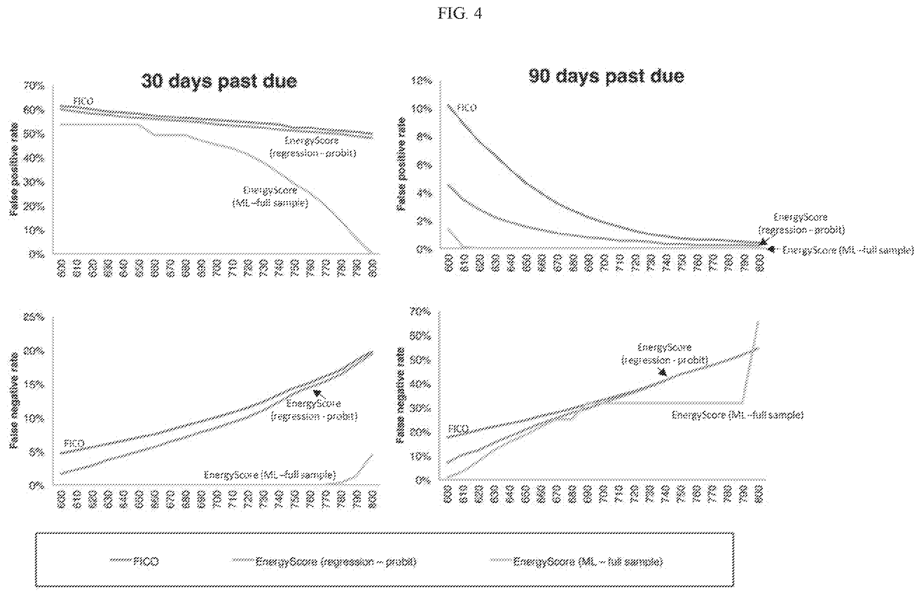

FIG. 4 shows the accuracy of the random forest algorithm relative to FICO. The false positive rate on the graphs in the first row indicate the percentage of those accepted that are ultimately delinquent on their payments, and the false negative rate on the graphs in the bottom row is the inverse—those rejected that would have been current on their payments. The graphs in the left-hand column are those using models that predict delinquencies of 30 days or more, and the graphs on the right-hand column are those using delinquencies of 90 days or greater.

The results indicate a number of significant trends. First, as discussed above, because monthly utility payment performance histories are incomplete, individuals who are delinquent on their payments tend to be over-represented in the restricted sample of accounts with 24 months of consecutive data. Second are the overall trends: the false positives are all downward-sloping and the false negatives are all upward-sloping. Such trends may be explained by the following: higher FICO-equivalent cutoffs imply higher selectivity, leading to lower delinquency rates and hence lower false positive rates. More stringent cutoffs also imply that more qualified applicants are being rejected, driving up the share of rejected applicants that end up paying on time, and by extension, the false negative rate.

Third is the fact that the machine learning curve has sections that are flat. These flat sections arise because the random forest algorithm optimizes the best splitting criterion for each branch of the decision tree in order to calculate the probability of delinquency. In other words, it assigns probabilities of delinquency by putting data points into categories according to the independent variables. An independent variable could be a binary variable, or it could be a continuous variable that is split based on a specific threshold. For example, the random forest algorithm may calculate the probability of delinquency based on whether the income code (an independent variable) is below the “$110K to $120K” category. Therefore, accounts with the same values for certain categories will have the same probability of delinquency, as opposed to a regression in which differing values for the covariates necessarily leads to differing results (i.e., the dependent variable). The random forest algorithm based on a 90-day definition of delinquency therefore assigns roughly 28% of the sample the same minimum probability of delinquency and another 1% the next lowest probability of delinquency. Since the accuracy rates are computed such that those below a particular cutoff are rejected, the accuracy curves move in a stepwise manner in the relevant ranges. For false negatives, since a high cutoff means most applicants are rejected, the false negative rate tends toward the sample non-delinquency rate above an 800 FICO equivalent cutoff.

Comparing the models, the random forest algorithm yields great gains in accuracy over a range of FICO cutoffs. For instance, when comparing to a FICO cutoff of 680, the random forest algorithm developed using a 30-day delinquency definition decreases the false positive rate by 7.0 percentage points (56.4% to 49.4%) and the false negative rate by 8.7 percentage points (8.7% to 0.0%). Similar gains are observed using a 90-day definition of delinquency. Here, the false positive rate (i.e. delinquencies among the approved pool) falls 2.7 percentage points (2.7% to 0.0%), while the false negative rate (i.e. rejected applicants being non-delinquent) falls 4.2 percentage points (29.5% to 25.3%).

The higher accuracy of the 90-day definition may be due to less noise. If delinquency is used as a measure of creditworthiness, delinquency using a 30-day definition could be noisier (i.e., it could be due to an error such as a misplaced bill) than a 90-day delinquency, which would more accurately indicate financial tendencies. This reasoning is consistent with the much higher explanatory power of the regressions using 90-day delinquency as the target, i.e., dependent variable.

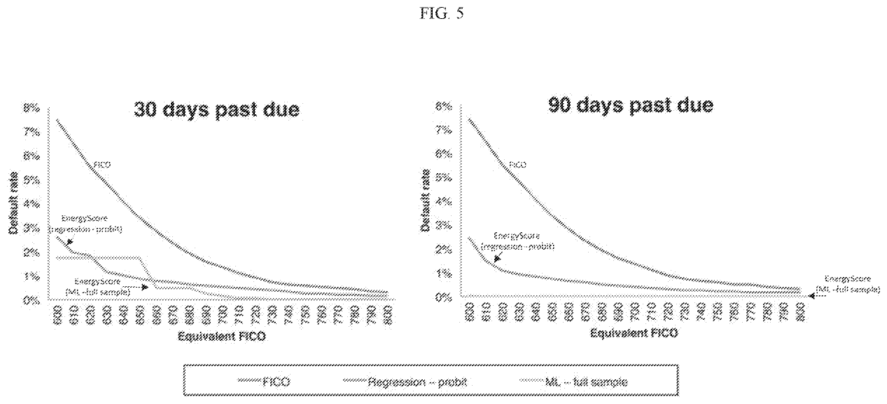

The stringency of the FICO score cutoff affects the default rate comparisons as shown in FIG. 5. A default is defined as an account that has, at any point in the 12-month period, either been transferred to a collections agency or turned off. Compared to a FICO score cutoff of 680, the default rate decreases by 1.4 percentage points (1.9% to 0.5%) using a 30-day delinquency definition and by 1.9 percentage points (1.9% to 0.0%) using a 90-day delinquency definition.

The random forest model, when tested with both 30- and 90-day definitions of delinquency, increases the number of LMI applicants approved, as seen in Table 6. Specifically, the random forest model using a 30-day definition increases the number of LMI accounts approved by 11.4% to 14.0% depending on the stringency, while the model using a 90-day definition increases LMI accounts approved by 1.1% to 4.2%. However, traditional regression techniques using a smaller set of variables resulted in slight decreases in the LMI population approved. This outcome could be due to the limited number of variables used in the regressions, which are highly correlated with income, whereas the random forest model uses the full data set.

TABLE 6
Change in number of LMI customers approved relative to a FICO cutoff

| | | |
|---|---|---|
| | | Random Forest |
| FICO equiv. | Regression | Machine Learning |

30 days past due

| | | |
|---|---|---|
| 650 | −3.8% | 13.4% |
| 680 | −7.3% | 14.0% |
| 700 | −8.9% | 11.4% |

90 days past due

| | | |
|---|---|---|
| 650 | −1.0% | 2.4% |
| 680 | −1.2% | 4.2% |
| 700 | −1.8% | 1.1% |

### Implications for Profitability

A profit model was developed to predict the expected profits of the firm when using the random forest algorithm-based model for enrolling potential customers for a community shared utility service. For purposes of enrollment, it was assumed that if a customer is offered the service, they choose to enroll. In this case, expected profits depend on the rule that dictates whether the service is offered to the customer and customers' default rates. Let the rule dictating whether the service is offered be denoted as, I(X), where X is a set of variables the firm uses to generate the “offering rule.” Similarly let I(Xᵢ) represent the indicator variable for whether consumer i is offered the service.

Consumers may default on paying for the service. For simplicity, imagine that the consumer defaults right away and all costs are up front, so that the firm never collects any revenues and incurs all of the costs. Let Pr(Dᵢ=1|Xᵢ) represent the probability consumer of type Xᵢ defaults.

First consider the profits of a firm that are not conditional on any information in X. Profits can be written as:

$$E [ {π}_{i} ( P , M , C ) ] = {\sum }_{i} [ P \cdot ( 1 - Pr ( {D}_{i} ) ) - MC \cdot I ( {X}_{i} ) ] , \qquad ( 9 )$$

where P is the price of the service and MC is the marginal cost. If this expression is positive, the firm offers the service to everyone; if it is negative, the firm exits. If the firm offers the service then it must be the case that the average repayment rate is greater than the ratio of marginal cost to price, given by:

$$1 - \overline{Pr ( {D}_{i} )} > \frac{MC}{P} \qquad ( 10 )$$

This expression can be rearranged to yield a condition on how the average default rate relates to the Lemer index:

$$\overline{Pr ( {D}_{i} )} < \frac{MC}{P} \qquad ( 11 )$$

Better scoring technology allows the firm to increase profits through eliminating customers that have negative expected profits. In particular, the firm's first order condition will imply probability of default for the marginal customer equals the Lemer index, given by:

$$\overline{Pr ( {D}_{i} \vert I ( {X}_{i} ) )} < \frac{P - MC}{P} \qquad ( 12 )$$

### Empirical Implementation

Though data on prices and costs are not available, the industry appears to utilize decision rules based on a prospective customer's FICO score to bound the ratio of marginal cost to price. For example, an often-cited decision rule is to offer customers the service if their FICO score is above 650. This rule, and similar rules based on FICO scores, can be used in two ways.

The first way uses the FICO score cutoff as a way to estimate the ratio of marginal cost to price. If decision rule is optimal, it implies that:

$$\overline{Pr ( {D}_{i} \vert FICO = 650 )} = \frac{P - MC}{P} \qquad ( 13 )$$

Therefore, given an estimate of the expected default rate of prospective customers with FICO scores of 650, the Lemer index can be estimated. One estimate of the left hand side of this equation is the average default rate for customers with FICO scores of 650. This estimate is empirically implemented by taking the empirical average default rate of customers with FICO scores of 650±X, where X is varied to gauge robustness. This defines the Lemer index used to gauge the benefits of improved alternatives to credit scoring for facilitating enrollment. To estimate the change in profits from different scoring rules, the price is normalized to be 1, implying marginal cost is Pr(Di|FICO=650). The profit obtained, when enrollment decisions are made using the random forest algorithm versus the FICO industry standard, is calculated using Equation 14.

$$E [ {π}_{i} ( P , M , C , I ( {X}_{i} ) ) ] = {\sum }_{i} P \cdot I ( {X}_{i} ) \cdot ( 1 - Pr ( {D}_{i} ) ) - MC \cdot I ( {X}_{i} ) \qquad ( 14 )$$

The results are displayed in Table 7.

As shown, regardless of the scoring stringency, determining enrollment using the random forest algorithm leads to an increase in profits for the firm over the FICO scoring cutoff method, which is a very significant result. The random forest algorithm benefits the prospective customers, by accepting LMI customers who otherwise would have been rejected using the traditional, FICO-based scoring method, and benefits the firms by increasing profits. Further, as the scoring stringency increases, the firm's profits decrease drastically using a FICO score cutoff, while the decrease is much more modest using comparatively stringent cutoffs using the random forest model. Accordingly, as stringency increases, there is a dramatic increase in profits obtained by using the random forest algorithm over the industry standard FICO scoring.

However, as shown in Table 8, the overall dollar value of the increase in profits from the random forest algorithm relative to a FICO score cutoff decreases as the FICO score cutoff becomes more stringent, because the firm is accepting and enrolling less customers overall. The increased profits from using the random forest algorithm can be attributed to two sources. First, there are increased profits due to accepting new customers who would have been denied under the FICO score cutoff, or a decrease in false negatives (“π from New Customers”). Second, there are reduced losses from rejecting those who are accepted under the FICO Score cutoff but whom the random forest algorithm identifies as high-risk, or a decrease in false positives (“π from Less Delinquents”). Note that these two columns do not sum up to the value in “Total π Increase” of Table 8. This is because the firm that uses the random forest algorithm would still lose profits by denying enrollment to a customer that would have otherwise brought them profits (i.e., by accepting some delinquents), who would have been correctly classified under a FICO score cutoff. Overall, however, the random forest algorithm methodology leads to an increase in profits when compared to the FICO score cutoff methodology, regardless of the stringency of the industry standard, due to the aggregate decrease in false positives and false negatives.

TABLE 7
Profit estimates for industry standard and random forest algorithm
at three different FICO cutoffs

| FICO | Industry | Random Forest | Total Percent |
|---|---|---|---|
| equiv. | Standard | Algorithm | Increase |
| 650 | $20,337.37 | $27,287.22 | 34% |
| 680 | $5,393.77 | $9,428.54 | 75% |
| 700 | $127.65 | $2,529.99 | 1882% |

TABLE 8
Profit increase between random forest algorithm and FICO score
attributed to new customers and by preventing delinquent customers

| FICO | π from New | π from Less | Total π |
|---|---|---|---|
| equiv. | Customers | Delinquents | Increase |
| 650 | $8,232.05 | $4,216.79 | $6,949.84 |
| 680 | $5,932.67 | $3,943.36 | $4,034.77 |
| 700 | $4,057.96 | $3,618.99 | $2,402.34 |

The present invention provides alternative methods of facilitating enrollment of customers in a community shared utility service, using a predictive machine learning model that more accurately predicts utility bill payment performance, which can be more inclusive of LMI individual account holders and which can generate more profit for the utility service, compared to the traditional method of relying on credit score cutoffs to determine enrollment eligibility. In certain embodiments of the present invention, benefits were observed using a variety of traditional regression approaches, as well as machine learning techniques, on a large data set, consisting of over 800,000 data points (samples), from a credit reporting agency (CRA) to develop models that predicts the probability of non-delinquency. In a preferred embodiment of the present invention, the method involves facilitating enrollment using a machine learning model according to the random forest algorithm as an alternative scoring mechanism. The random forest predictive model exhibited high accuracy rates, a reasonable computation time, and comprehensive interpretability. In certain embodiments, the random forest model increases the number of LMI applicants approved by 1.1% to 4.2%, while decreasing the default rate by 1.4 to 1.9 percentage points depending on the delinquency definition and stringency of the cutoff. In other embodiments, the methods encompassed by the present invention involve facilitating enrollment using a traditional regression analysis based on a small number of variables specific to utility repayment performance, as an alternative scoring mechanism, traditional regression analysis greatly increased accuracy and LMI inclusivity relative to FICO. The present invention demonstrates that it is possible to extend a community utility service such as solar to a larger number of qualified applicants with lower or no credit scores while decreasing default risk and generating higher profits, thus representing an untapped, low-risk market segment.

TABLE 9
Full regression specifications for probability of delinquency using 30-day definition

| | LPM | Probit | LPM | Probit | LPM |
|---|---|---|---|---|---|
| Regresssor | (1) | (2) | (3) | (4) | (5) |
| 30DaysPastDue | 0.252*** | 1.852*** | 0.146*** | 1.474*** | 0.147*** |
| | (0.00122) | (0.0166) | (0.00120) | (0.0173) | (0.00122) |
| 60DaysPastDue | −0.0352*** | 0.243*** | −0.0160*** | 0.0457*** | −0.00688*** |
| | (0.00139) | (0.0136) | (0.00122) | (0.0129) | (0.00124) |
| 90DaysPastDue | 0.274*** | 1.532*** | 0.0939*** | 0.908*** | 0.0886*** |
| | (0.000766) | (0.00770) | (0.00101) | (0.00919) | (0.00101) |
| FICO | | | −0.00115*** | −0.00328*** | −0.00105*** |
| | | | (5.29e−06) | (2.42e−05) | (5.49e−06) |
| FICOBlank | | | −0.631*** | −1.653*** | −0.574*** |
| | | | (0.00327) | (0.0207) | (0.00338) |
| NewMover | | | | | 0.0394*** |
| | | | | | (0.00427) |
| HomeOwner | | | | | −0.0479*** |
| | | | | | (0.00102) |
| Multifamily | | | | | 0.0809*** |
| | | | | | (0.00130) |
| Income | | | | | |
| College | | | | | |
| Constant | 0.617*** | 0.249*** | 1.459*** | 2.699*** | 1.415*** |
| | (0.000689) | (0.00189) | (0.00378) | (0.0184) | (0.00384) |
| N | 697,762 | 697,762 | 697,762 | 697,762 | 697,762 |
| R² | 0.147 | 0.193 | 0.197 | 0.223 | 0.204 |

| | Probit | LPM | Probit |
|---|---|---|---|
| Regresssor | (6) | (7) | (8) |
| 30DaysPastDue | 1.483*** | 0.142*** | 1.472*** |
| | (0.0172) | (0.00122) | (0.0172) |
| 60DaysPastDue | 0.104*** | −0.00388*** | 0.120*** |
| | (0.0130) | (0.00125) | (0.0131) |
| 90DaysPastDue | 0.891*** | 0.0867*** | 0.888*** |
| | (0.00941) | (0.00102) | (0.00947) |
| FICO | −0.00279*** | −0.000951*** | −0.00244*** |
| | (2.51e−05) | (5.64e−06) | (2.56e−05) |
| FICOBlank | −1.316*** | −0.525*** | −1.107*** |
| | (0.0213) | (0.00344) | (0.0217) |
| NewMover | 0.129*** | 0.0434*** | 0.141*** |
| | (0.0156) | (0.00425) | (0.0157) |
| HomeOwner | −0.290*** | −0.0288*** | −0.217*** |
| | (0.00624) | (0.00105) | (0.00636) |
| Multifamily | 0.362*** | 0.0771*** | 0.343*** |
| | (0.00702) | (0.00130) | (0.00706) |
| Income | | −0.0134*** | −0.0526*** |
| | | (0.000225) | (0.000930) |
| College | | −0.0388*** | −0.124*** |
| | | (0.00114) | (0.00388) |
| Constant | 2.544*** | 1.422*** | 2.584*** |
| | (0.0190) | (0.00385) | (0.0192) |
| N | 697,762 | 697,762 | 697,762 |
| R² | 0.233 | 0.211 | 0.239 |

Robust standard errors in parentheses (***pi0.01, **pi0.05, *pi0.1). All specifications also include indicator variables for missing demographic variables.

TABLE 10
Full regression specifications for probability of delinquency using 90-day definition

| | LPM | Probit | LPM | Probit | LPM |
|---|---|---|---|---|---|
| Regresssor | (1) | (2) | (3) | (4) | (5) |
| 30DaysPastDue | 0.621*** | 2.808*** | 0.480*** | 2.213*** | 0.479*** |
| | (0.00205) | (0.0118) | (0.00196) | (0.0122) | (0.00196) |
| 60DaysPastDue | −0.138*** | 0.0485*** | −0.113*** | −0.0662*** | −0.110*** |
| | (0.00237) | (0.0117) | (0.00203) | (0.0106) | (0.00204) |
| 90DaysPastDue | 0.649*** | 2.720*** | 0.425*** | 1.676*** | 0.421*** |
| | (0.00108) | (0.00703) | (0.00128) | (0.00829) | (0.00128) |
| FICO | | | −0.00143*** | −0.00852*** | −0.00139*** |
| | | | (4.13e−06) | (3.92e−05) | (4.27e−06) |
| FICOBlank | | | −0.745*** | −4.392*** | −0.723*** |
| | | | (0.00285) | (0.0267) | (0.00291) |
| NewMover | | | | | −0.00324 |
| | | | | | (0.00246) |
| HomeOwner | | | | | −0.0358*** |
| | | | | | (0.000912) |
| Multifamily | | | | | −0.0171*** |
| | | | | | (0.000992) |
| Income | | | | | |
| College | | | | | |
| Constant | 0.0882*** | −1.623*** | 1.133*** | 4.149*** | 1.138*** |
| | (0.000326) | (0.00321) | (0.00327) | (0.0260) | (0.00330) |
| N | 697,762 | 697,762 | 697,762 | 697,762 | 697,762 |
| R² | 0.687 | 0.667 | 0.757 | 0.753 | 0.758 |

| | Probit | LPM | Probit |
|---|---|---|---|
| Regresssor | (6) | (7) | (8) |
| 30DaysPastDue | 2.209*** | 0.477*** | 2.205*** |
| | (0.0121) | (0.00196) | (0.0122) |
| 60DaysPastDue | −0.0498*** | −0.109*** | −0.0420*** |
| | (0.0107) | (0.00203) | (0.0108) |
| 90DaysPastDue | 1.664*** | 0.421*** | 1.662*** |
| | (0.00831) | (0.00128) | (0.00833) |
| FICO | −0.00828*** | −0.00136*** | −0.00805*** |
| | (4.00e−05) | (4.33e−06) | (4.03e−05) |
| FICOBlank | −4.237*** | −0.709*** | −4.110*** |
| | (0.0274) | (0.00293) | (0.0276) |
| NewMover | −0.0176 | −0.00199 | −0.00153 |
| | (0.0257) | (0.00246) | (0.0257) |
| HomeOwner | −0.205*** | −0.0301*** | −0.144*** |
| | (0.00694) | (0.000922) | (0.00713) |
| Multifamily | −0.0872*** | −0.0188*** | −0.0958*** |
| | (0.00823) | (0.000994) | (0.00826) |
| Income | | −0.00514*** | −0.0467*** |
| | | (0.000143) | (0.00139) |
| College | | −0.00354*** | −0.0711*** |
| | | (0.000599) | (0.00689) |
| Constant | 4.154*** | 1.143*** | 4.220*** |
| | (0.0264) | (0.00331) | (0.0266) |
| N | 697,762 | 697,762 | 697,762 |
| R² | 0.754 | 0.759 | 0.756 |

Robust standard errors in parentheses (***pi0.01, **pi0.05, *pi0.1). All specifications also include indicator variables for missing demographic variables.

TABLE 11
Top 100 variables for random forest-based predictive model

| Var Name | Meaning |
|---|---|
| DELQ90_84MO_CT | 90-180 day delinquencies |
| ACCT_CHARGE_OFF_AM | Account charge-off amount |
| ACCT_COND_CD | Account condition |
| ACCT_STATUS_CD | Account status |
| ENHANCED_ACCT_STATUS_CD | Account status, detailed |
| ACCT_REPORTED_AGE_MO | Age of account in months |
| AMOUNT_1 | Amount 1: high balance or charge-off |
| AMOUNT_1 QUALIFIER | Amount 1: high balance or charge-off, qualifier |
| AMOUNT_2 | Amount 2: high balance or charge-off |
| AMOUNT_2_QUALIFIER | Amount 2: high balance or charge-off, qualifier |
| CREDIT_AM | Amount owed |
| ACCT_PAST_DUE_AM | Amount past due |
| PREMIER_V1_2_ALL8353 | Average no. of mos. on trades since most recent |
| | 60, 90, and 120-180 day delinquency and |
| | derogatory excluding collections including |
| | indeterminates |
| PREMIER_V1_2_ALL8323 | Average no. of mos. 90 or more days delinquent |
| | or derogatory trades were opened excluding |
| | collections including indeterminates |
| PREMIER_V1_2_ALL8325 | Average no. of mos. 90 or more days delinquent |
| | or derogatory trades were opened including |
| | collections and indeterminates |
| ACCT_BALANCE_AM | Balance amount |
| DPD30_KEYCD_24 | Binary variable if any occurrence of delinquency |
| | for at least 30 days past the due date |
| DELQ_DT_EXCP_CD_1 | Exception code for most recent delinquency date |
| | (e.g., balance forward, account $ transfer, late |
| | fees) |
| DELQ_DT_EXCP_CD 2 | Exception code for second most recent |
| | delinquency date (e.g., balance forward, account $ |
| | transfer, late fees) |
| GRID_FLAG_ARF6 | Flag for FACT Act Alert (fraud prevention) |
| TERMS_FREQ_CD | Frequency in which payments are due |
| SUBSCRIBER_ID | ID number of utility reporting trade data to |
| | Experian |
| DEROG_84MO_CT | Number of months the account reported as |
| | seriously derogatory (180+ days) |
| INDUSTRY | Industry of creditor |
| LAST_PAYMENT_DT | Last payment date |
| PREMIER_V1_2_ALL5460 | Maximum amount owed on unsatisfied |
| | derogatory trades including collection |
| AMOUNT_1_blank | Missing amount 1: high balance or charge-off |
| AMOUNT_1_QUALIFIER_blank | Missing amount 1: high balance or charge-off, |
| | qualifier |
| AMOUNT_2_QUALIFIER_blank | Missing amount 2: high balance or charge-off, |
| | qualifier |
| AMOUNT_2_blank | Missing: Amount 2 |
| CREDIT_AM_blank | Missing: Amount owed |
| ACCT_PAST_DUE_AM_blank | Missing: Amount past due |
| TERMS_FREQ_CD_blank | Missing: Frequency in which payments are due |
| LAST_PAYMENT_DT_blank | Missing: Last payment date |
| DELQ_DT_1_blank | Missing: Most recent delinquency date |
| ACCT_DOLLAR_AM_blank | Missing: Original amount owed |
| PAYMENT_GRID_8479_blank | Missing: Payment history grid (Version 8): 67th |
| | most recent month |
| PAYMENT_GRID 8480_blank | Missing: Payment history grid (Version 8): 68th |
| | most recent month |
| DELQ_DT_1_AGE_MO_blank | Missing: Time since most recent delinquency date |
| | in months |
| DELQ_DT_2_AGE_MO_blank | Missing: Time since second most recent |
| | delinquency date in months |
| DELQ_DT_1 | Most recent delinquency date |
| PREMIER_V1_2_ALL8558 | Number of months since most recent 90 or more |
| | days delinquency or derogatory excluding |
| | collections including indeterminates |
| PREMIER_V1_2_ALL8164 | Number of months since the most recent charge- |
| | off including indeterminates |
| PREMIER_V1_2_ALL8560 | Number of months since the most recent |
| | derogatory on trades excluding collections |
| | including indeterminates |
| PREMIER_V1_2_ALL8223 | Number of months since the oldest and ever 90 or |
| | more days delinquent or derogatory trades was |
| | opened excluding collections including |
| | indeterminates |
| ACCT_DOLLAR_AM | Original amount owed |
| PREMIER_V1_2_ALL7170 | Overall amount past due to balance ratio on trades |
| | reported in the last 6 months excluding collections |
| PAYMENT_GRID_8427 | Payment history grid (Version 8): 15th most |
| | recent month |
| PAYMENT_GRID_8428 | Payment history grid (Version 8): 16th most |
| | recent month |
| PAYMENT_GRID_8435 | Payment history grid (Version 8): 23rd most |
| | recent month |
| PAYMENT_GRID_8437 | Payment history grid (Version 8): 25th most |
| | recent month |
| PAYMENT_GRID_8444 | Payment history grid (Version 8): 32nd most |
| | recent month |
| PAYMENT_GRID_8482 | Payment history grid (Version 8): 70th most |
| | recent month |
| PREMIER_V1_2_ALL7440 | Percentage of trades excluding collections that are |
| | ever 30 or more days delinquent or derogatory |
| PREMIER_V1_2_ALL7450 | Percentage of trades excluding collections that are |
| | ever 60 or more days delinquent or derogatory |
| PREMIER_V1_2_ALL7460 | Percentage of trades excluding collections that are |
| | ever 90 or more days delinquent or derogatory |
| PREMIER_V1_2_ALL7470 | Percentage of trades excluding collections that are |
| | ever derogatory |
| PREMIER_V1_2_ALL7330 | Percentage of trades excluding collections that are |
| | never delinquent or derogatory |
| PREMIER_V1_2_ALL7340 | Percentage of trades including collections that are |
| | ever 30 or more days delinquent or derogatory |
| PREMIER_V1_2_ALL7350 | Percentage of trades including collections that are |
| | ever 60 or more days delinquent or derogatory |
| PREMIER_V1_2_ALL7370 | Percentage of trades including collections that are |
| | ever derogatory |
| PREMIER_V1_2_ALL7331 | Percentage of trades including collections that are |
| | never delinquent or derogatory |
| PREMIER_V1_2_ALL7936 | Percentage of trades reported in the last 6 months |
| | including collections that are never delinquent or |
| | derogatory occurred in the last 6 months |
| DELQ_DT_2_blank | Second most recent delinquency date is missing |
| DEL__DT_2 | Second most recent delinquency date |
| DELQ_DT_1_AGE_MO | Time since most recent delinquency date in |
| | months |
| DELQ_DT_2_AGE_MO | Time since second most recent delinquency date |
| | in months |
| PREMIER_V1_2_UTI5030 | Total balance on open, or closed with a balance > |
| | $0 utility trades, reported in the last 6 months |
| | excluding derogatory trades |
| PREMIER V1 2 ALL5073 | Total balance on trades presently derogatory |
| | excluding collections |
| PREMIER_V1_2_ALM5072 | Total balance on trades presently derogatory |
| | including unsatisfied non-medical collections |
| PREMIER_V1_2_ALL2322 | Total number of trades ever 30 days delinquent |
| | that occurred more than 2 times, or ever 60 or |
| | more days delinquent or derogatory excluding |
| | collections |
| PREMIER_V1_2_ALM2350 | Total number of trades ever 60 or more days |
| | delinquent or derogatory including non-medical |
| | collections |
| PREMIER_V1_2_ALM2390 | Total number of trades ever 90 or more days |
| | delinquent including collections, or public records |
| PREMIER_V1_2_ALL2480 | Total number of trades ever 90 or more days |
| | delinquent or derogatory excluding collections |
| PREMIER_V1_2_ALL2490 | Total number of trades ever 90 or more days |
| | delinquent or derogatory excluding collections, |
| | and including public records |
| PREMIER_V1_2_ALM2389 | Total number of trades ever 90 or more days |
| | delinquent or derogatory including collections |
| | (excluding satisfied medical collections) |
| PREMIER_VI_2_ALL2800 | Total number of trades ever derogatory excluding |
| | collections |
| PREMIER_V1_2_ALL2700 | Total number of trades ever derogatory including |
| | collections |
| PREMIER_V1_2_ALM2709 | Total number of trades ever derogatory including |
| | collections (excluding satisfied medical |
| | collections) |
| PREMIER_V1_2_ALM2729 | Total number of trades ever derogatory including |
| | collections, or public records |
| PREMIER_V1_2_ALL2720 | Total number of trades ever derogatory including |
| | collections, or public records |
| PREMIER_V1_2_ALM2700 | Total number of trades ever derogatory including |
| | non-medical collections |
| PREMIER_V1_2_ALM2720 | Total number of trades ever derogatory including |
| | non-medical collections, or public records |
| PREMIER_V1_2_ALL0060 | Total number of trades excluding collections |
| | opened after most recent trade derogatory |
| | (including collections and indeterminates), or |
| | public record bankruptcy |
| PREMIER_V1_2_ALL2008 | Total number of trades never delinquent or |
| | derogatory opened after the most recent trade |
| | derogatory (excluding collections and including |
| | indeterminates), or public record bankruptcy |
| PREMIER_V1_2_ALL2009 | Total number of trades never delinquent or |
| | derogatory opened after the most recent trade |
| | derogatory (including collections and |
| | indeterminates), or public record bankruptcy |
| PREMIER_V1_2_ALL2220 | Total number of trades presently 30 or more days |
| | delinquent or derogatory excluding collections |
| PREMIER_V1_2_ALL2120 | Total number of trades presently 30 or more days |
| | delinquent or derogatory including collections |
| PREMIER_V1_2_ALL3311 | Total number of unsatisfied charge-off trades with |
| | a balance > $100 |
| PREMIER_V1_2_ALL6900 | Worst ever status on a trade excluding collections |
| | including indterminates |
| PREMIER_V1_2_ALM6280 | Worst ever status on a trade in the last 23 months |
| | including non-medical collections and |
| | indeterminates |
| PREMIER_V1_2_ALM6209 | Worst ever status on a trade including collections |
| | (excluding satisfied medical collections) and |
| | indeterminates |
| PREMIER_V1_2_ALM6200 | Worst ever status on a trade including non- |
| | medical collections and indeterminates |
| PREMIER_V1_2_UTI6280 | Worst ever status on a utility trade in the last 24 |
| | months including indeterminates |
| PREMIER_V1_2_UTI6200 | Worst ever status on a utility trade including |
| | indeterminates |
| PREMIER_V1_2_ALL6400 | Worst present status on a trade excluding |
| | collections including indeterminates |
| PREMIER_V1_2_ALL6100 | Worst present status on a trade including |
| | collections and indeterminates |
| PREMIER_V1_2_ALL6460 | Worst present status on a trade reported in the last |
| | 6 months excluding collections including |
| | indeterminates |
| PREMIER_V1_2_ALM6169 | Worst present status on a trade reported in the last |
| | 6 months including collections (excluding |
| | satisfied medical collections) and indeterminates |
| PREMIER_V1_2_ALL6160 | Worst present status on a trade reported in the last |
| | 6 months including collections and indeterminates |

1. A method of providing, to a utility service entity, an applicant's probability of delinquency for utility bill payment, the method comprising:
(a) training a predictive model to provide probabilities of delinquency on utility bill payment, wherein the training is performed using a dataset comprising data points representing information associated with a number of individual utility service account holders;
(b) collecting demographic data and financial data about an applicant;
(c) applying the demographic data and financial data to the predictive model to obtain a probability of delinquency on utility bill payment for the applicant, and
(d) providing the probability of delinquency on utility bill payment for the individual applicant to the utility service entity.

2. A method of providing, to a utility service entity, a determination of qualification for an applicant's enrollment in a utility service, the method comprising:
(a) training a predictive model to provide a probability of delinquency on utility bill payment, wherein the training is performed using a dataset comprising data points representing information associated with a number of individual utility service account holders;
(b) collecting demographic data and financial data about an applicant;
(c) applying the demographic data and financial data to the predictive model to obtain, for the applicant, a probability of delinquency on utility bill payment;
(d) assigning to the applicant a determination of qualification for enrollment in the utility service that is based on the probability of delinquency on utility bill payment for the applicant; and
(e) providing the determination of qualification for enrollment in the utility service to the utility service entity.

3. The method according to any one of claims 1-2, wherein the probability of delinquency that is obtained is the probability of being over 90 days past due on utility bill payment.

4. The method according to any one of claims 1-2, wherein the probability of delinquency that is obtained is the probability of being 60 days past due on a utility bill payment.

5. The method according to any one of claims 1-4, wherein the applicant does not have a FICO score.

6. The method according to any one of claims 1-5, wherein the applicant has a household income that is below the 40th percentile of incomes in the applicant's county of residence.

7. A method of providing, to a utility service entity, probabilities of utility payment delinquency for multiple applicants, the method comprising:
(a) training a predictive model to provide probabilities of delinquency on utility bill payment, wherein the training is performed using a dataset comprising data points representing information associated with a number of individual utility service account holders;
(b) collecting demographic data and financial data for each of said multiple applicants;
(c) applying the demographic data and financial data to the predictive model to obtain, for each of said multiple applicants, a corresponding probability of delinquency on utility bill payment, and
(d) providing said corresponding probability of delinquency for each of said multiple applicants to the utility service entity.

8. A method of providing, to a utility service entity, determinations of qualification for enrollment in a utility service as to multiple applicants, the method comprising:
(a) training a predictive model to provide probability delinquency on utility bill payment, wherein the training is performed using a dataset comprising data points representing information associated with a number of individual utility service account holders;
(b) collecting demographic data and financial data for each of said multiple applicants;
(c) applying the demographic data and financial data to the predictive model to obtain, for each of said multiple applicants, a corresponding probability of delinquency on utility bill payment;
(d) assigning to each of said multiple applicants a determination of qualification for enrollment in the utility service that is based on said corresponding probability of delinquency on utility bill payment for the applicant; and
(e) providing said determinations to the utility service entity.

9. The method according to any one of claims 7-8, wherein the corresponding probability of delinquency on utility bill payment that is obtained for each of said multiple applicants is the probability of being over 90 days past due on utility bill payment.

10. The method according to any one of claims 7-9, wherein said multiple applicants comprises at least 100 applicants.

11. The method according to any one of claims 7-10, wherein at least 10 percent of said multiple applicants have no FICO score.

12. The method according to claim 8, wherein at least 10 percent of said determinations are a determination that the applicant qualifies for enrollment.

13. The method according to claim 12, wherein at least 5 percent of the determinations that the applicant qualifies for enrollment are for applicants each with a household income that is below the 40th percentile of incomes in the applicant's county of residence.

14. The method of claim 12, wherein at least 5 percent of the determinations that the applicant qualifies for enrollment are for applicants without a FICO score.

15. A method of enrolling one or more applicants in a utility service, the method comprising enrolling in the utility service at least one applicant based on the applicant's probability of delinquency on utility bill payment, wherein the applicant's probability of delinquency on utility bill payment is determined by applying demographic data and financial data for the applicant to a predictive model that has been trained, tested, and validated using a dataset comprising data points representing past information associated with a number of individual utility service account holders.

16. The method according to claim 15, wherein the applicant's probability of delinquency is a probability of being over 90 days past due on a utility bill payment.

17. The method according to claim 15, wherein the applicant's probability of delinquency is a probability of being 60 days past due on a utility bill payment.

18. The method according to any one of claims 15-17, wherein the applicant does not have a FICO score.

19. The method according to any one of claims 15-18, wherein the applicant has a household income that is below the 40th percentile of incomes in the applicant's county of residence.

20. The method according to any one of claims 1-19, wherein the predictive model has been trained, tested, and validated according to a machine learning technique.

21. The method according to claim 20, wherein the machine learning technique comprises random forest classification.

22. The method according to any one of claims 1-21, wherein the number of individual utility service account holders is at least 800,000.

23. The method according to any one of claims 1-14, wherein the utility service entity provides a utility service.

24. The method according to any one of claims 15-19, wherein the utility service is a community shared utility.

25. The method according to claim 24, wherein the community shared utility is community shared solar.

26. The method according to any one of claims 1-25, wherein the predictive model includes at least 5,000 features, each of the features being weighted according to the feature's contribution in the predictive model for predicting probability of delinquency on utility bill payment, wherein none of the twenty (20) highest-weighted features is a demographic variable.

27. The method according to any one of claims 1-26, wherein the demographic data comprise data for the following variables: home ownership, a move within the last 12 months, college education.

28. The method according to any one of claims 1-27, wherein the financial data comprise data for the following variables: most recent delinquency date, amount past due, number of 90-180 day delinquencies.

29. The method according to any one of claims 15-19, the method further comprising providing a utility service to the at least one applicant.

30. A method of facilitating enrollment of one or more applicants in a community shared utility service using a predictive model, the method comprising:
(a) receiving demographic data and financial data for each of one or more applicants;
(b) applying a predictive model to the demographic data and financial data to obtain a probability of delinquency on a utility bill payment for each of the one or more applicants, wherein the predictive model is a machine learning model that has been trained, tested, and validated using a dataset comprising data points representing past information associated with a number of individual utility service account holders;
(c) assigning, to each of the one or more applicants, a determination of qualification for enrollment in the community shared utility service based on the probability of delinquency obtained for each of the one or more applicants;
(d) providing said determinations to a utility service provider in order to facilitate enrollment in the community shared utility service.

31. A method of obtaining a probability of delinquency for an applicant's payment in a community shared utility, the method comprising:
(a) training a random forest predictive model to provide a probability of delinquency on utility bill payment, wherein the training is performed using a dataset comprising data points representing information associated with a number of individual utility service account holders;
(b) collecting an applicant's demographic data and financial data;
(c) applying the demographic data and financial data to the random forest predictive model to obtain a probability of delinquency for the applicant's payment in a community shared utility.

32. The method according to claim 31, wherein the applicant's demographic data comprises home ownership, date of last move, and education level.

33. The method according to any one of claims 31-32, wherein the applicant's financial data comprises the number of 90-180 day delinquencies, amount owed, and amount past due.

34. The method according to any one of claims 30-33, wherein the probability of delinquency that is obtained is the probability of being over 90 days past due on a utility bill payment.

35. A non-transitory computer-readable medium having stored thereon computer-readable instructions that when executed by a computing device cause the computing device to: (a) access an individual's demographic data and financial data from memory; (b) process the individual's demographic data and financial data through a random forest classifier to compute a probability of being delinquent on a utility bill payment.

36. A method, comprising:
(a) storing, in a database, demographic data and financial data for each member of a group of individual utility account holders;
(b) evaluating, by a computing apparatus, a plurality of pre-defined features from each member of the group of individual utility account holders based on the demographic data and the financial data stored in the database;
(c) generating, by the computing apparatus, an aggregated dataset of the pre-defined features;
(d) separating, by the computing apparatus, the aggregated dataset into a training dataset and a test dataset;
(c) applying, by the computing apparatus, a machine learning technique to the training dataset to derive a predictive model that correlates the features for each of said individual utility account holders with a probability of delinquency on a utility bill payment;
(d) applying, by the computing apparatus, the predictive model to the testing dataset to yield a determination of whether the accuracy of predictions from the predictive model is above a pre-defined threshold; and
(e) following a determination that the accuracy of predictions from the predictive model for the testing dataset is above the pre-defined threshold, applying, by the computing apparatus, the predictive model to a utility service applicant's demographic data and financial data to generate a prediction as to whether the applicant will be delinquent on a utility bill payment.

37. The method according to claim 36, wherein the machine learning technique is a random forest analysis.

38. The method according to any one of claims 36-37, wherein the plurality of pre-defined features comprises at least 5,000 features.

39. The method according to any one of claims 36-38, further comprising: computing, by the computing apparatus, contributions of the pre-defined features in the predictive model for making predictions; ranking, by the computing apparatus, the pre-defined features based on the contributions of the features; and optionally providing, by the computing apparatus and based on the ranking, a user interface presenting top-contributing features in the predictive model for making predictions.

40. The method according to claim 39, wherein the 100 top-contributing features are financial variables.

41. The method according to any one of claims 36-40, wherein the prediction as to whether the applicant will be delinquent on a utility bill payment is a prediction as to whether the applicant will be 60 days past due on a utility bill payment.

42. The method according to any one of claims 36-40, wherein the prediction as to whether the applicant will be delinquent on a utility bill payment is a prediction as to whether the applicant will be over 90 days past due on a utility bill payment.

43. A non-transitory computer-readable medium having stored thereon instructions configured to instruct a computing device to perform a method, the method comprising:
(a) storing, in a database, demographic data and financial data for each member of a group of individual utility account holders;
(b) evaluating, by a computing apparatus, a plurality of pre-defined features for each member of the group of individual utility account holders based on the demographic data and the financial data stored in the database;
(c) generating, by the computing apparatus, an aggregated dataset of the features for the group of individual utility account holders;
(d) separating, by the computing apparatus, the aggregated dataset into a training dataset and a test dataset;
(c) applying, by the computing apparatus, a machine learning technique to the training dataset to derive a predictive model that correlates the features for each member of the group of individual utility account holders with a probability of delinquency on a utility bill payment;
(d) applying, by the computing apparatus, the predictive model to the testing dataset to yield a determination of whether the accuracy of predictions from the predictive model is above a pre-defined threshold; and
(e) in response to a determination that the accuracy of predictions from the predictive model for the testing dataset is above the pre-defined threshold, applying, by the computing apparatus, the predictive model to an applicant's demographic data and financial data to generate a prediction as to whether the applicant will be delinquent on a utility bill payment.

44. The non-transitory computer-readable medium according to claim 43, wherein the machine learning technique is a random forest analysis.

45. A method of using a predictive model for the enrollment of one or more applicants in a community shared utility service, the method comprising:
(a) collecting demographic data and financial data for each of one or more applicants;
(b) applying said demographic data and financial data to a predictive model to obtain a probability of delinquency on a utility bill payment for each of the one or more individuals, wherein the predictive model has been trained, tested, and validated using a dataset comprising data points representing past information associated with a number of individual utility service account holders;
(c) assigning a determination of qualification for said community shared utility service to each of the one or more applicants based on said probability of delinquency, and
(d) providing said determination of qualification for said community shared utility service to a utility company.

46. The method according to claim 45, wherein the predictive model is a machine learning technique.

47. The method according to claim 46, wherein the machine learning technique is a random forest classification.

48. The method according to any one of claims 45-47, wherein the community shared utility service is community shared solar.

49. The method according to any one of claims 45-48, wherein the dataset comprising data points representing past information associated with a number of individual utility service account holders comprises at least 800,000 data points.

50. The method according to any one of claims 45-49, wherein said predictive model uses at least 5,000 features, said features weighted according to importance, and wherein none of the twenty (20) highest-weighed features are demographic data.

51. A method of obtaining a probability of delinquency for an applicant's payment in a community shared utility, said method comprising:
(a) collecting the applicant's demographic data and financial data;
(b) applying a random forest analysis to the demographic and financial data to obtain a probability of delinquency for the applicant's payment in a community shared utility.
